(19) United States
(12) Patent Application Publication
(10) Pub. No.: US 2010/0095201 A1
(43) Pub. Date: Apr. 15, 2010

(54) ELECTRONIC BOOK CONTENTS RECORDING MEDIUM WITH ELECTRONIC BOOK CONTENTS RECORDED THEREON, ELECTRONIC BOOK TRANSMISSION APPARATUS AND ELECTRONIC BOOK DISPLAY APPARATUS

(75) Inventor: Yuji Sawada, Osaka (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/638,217

(22) Filed: Dec. 15, 2009

Related U.S. Application Data
(63) Continuation of application No. 10/049,315, filed on Feb. 8, 2002, now abandoned.

(30) Foreign Application Priority Data
Aug. 10, 1999 (JP) 11-226607

(51) Int. Cl. G06F 17/00

(52) U.S. Cl. 715/234

(57) ABSTRACT

An electronic book data includes a body data unit (12) and a part data unit (13). The body data unit (12) includes event data (124) having a description for designating a display region and a first identifier for designating contents displayed on the display region, and the part data unit (13) includes object information divided into a plurality of regions (133) to which the first identifier is added. The event data (124) thus includes the description for designating the display region and the first identifier for designating the contents to be displayed on the display region, and accordingly the first identifier added to the object information (133) can be referred to so as to acquire an object entity (132) displayed on the display region.

### TECHNICAL FIELD

The present invention relates to a structure of electronic book contents and a technique of processing the electronic book contents. In particular, the invention relates to a structure of electronic book contents constituted of data files each manageable easily, an electronic book transmission apparatus for transmitting the electronic book contents and an electronic book display apparatus for displaying the electronic book contents.

### BACKGROUND ART

In recent years, some writings like books are produced as electronic ones to be distributed in the market in the same form as that of software. Moreover, the globally widespread Internet allows users to obtain various types of information via the Internet by means of terminals such as personal computers. Accordingly, a service of providing electronic book contents via the Internet to users is performed by describing electronic books by text in HTML (Hyper Text Markup Language).

FIG. 1 shows one example of electronic book contents described by text in HTML. The first <html> tag indicates that the following text is described in HTML. The next <body> tag indicates that the following text is the body of the electronic book. In the body between <body> tag and </body> tag, image data “Fig.jpg” are embedded at two locations by <img src> tags.

In order to replace the image data “Fig.jpg” with another image data, for example, “Fig2.jpg”, <img src=“Fig.jpg”> at two locations must be retrieved and corrected. In particular, when the body is longer and accordingly the same images are used at an increased number of locations, a problem arises that replacement of the images becomes more difficult.

The present invention is made to solve the problem above and one object of the invention is to provide electronic book contents which can be edited in a shorter time.

Another object of the invention is to provide electronic book contents with copyright manageable on the basis of smaller units and thus enable the electronic book contents to be sold chapter by chapter.

Still another object of the invention is to provide electronic book contents adaptable to various forms of display.

A further object of the invention is to provide electronic book contents which can be displayed according to the performance of an electronic book display apparatus.

A further object of the invention is to provide an electronic book display apparatus capable of displaying the electronic book contents achieving the objects above.

A further object of the invention is to provide an electronic book transmission apparatus capable of transmitting the electronic book contents achieving the objects above.

### DISCLOSURE OF THE INVENTION

According to one aspect of the present invention, electronic book contents include a body data unit and a part data unit. The body data unit includes event data including a description for designating a display region and a first identifier for designating contents displayed on the display region. The part data unit includes display data divided into a plurality of regions with the first identifier added thereto.

As the event data includes the description for designating the display region and the first identifier for designating the contents displayed on the display region, the display data can be acquired and then displayed on the display region by referring to the first identifier added to the display data.

Preferably, the event data includes a description for designating the display region for each page and the first identifier.

As the event data includes the description for designating the display region for each page and the first identifier, it is possible to jump to another page at random and to sell the contents page by page in an easy manner.

Preferably, the event data further includes a second identifier for designating sound data to be reproduced, and the part data unit further includes the sound data divided into a plurality of regions with the second identifier added thereto.

As the event data includes the second identifier for designating sound data to be reproduced, the sound data can be acquired and then reproduced by referring to the second identifier added to the sound data.

Still preferably, the display data includes text data and image data, and at least two types of copyright information are described for the text data, image data and sound data.

At least two types of copyright information are described for the text data, image data and sound data, and accordingly copyright can be managed on the basis of smaller units.

Preferably, the body data unit includes a plurality of event data corresponding to a plurality of display forms.

As the body data unit includes a plurality of event data adapted to a plurality of display forms, any special display like display of a double page spread for example is possible.

Preferably, the electronic book contents include a plurality of body data units corresponding to types of electronic book display apparatuses.

As the electronic book contents include a plurality of body data units adapted to types of electronic book display apparatuses, the electronic book contents can be displayed suitably for performance of an electronic book display apparatus.

Preferably, the body data unit further includes chapter structure information describing a chapter structure of a book, and the chapter structure information describes information for designating a method of controlling trial reading for each chapter.

As information for designating a method of controlling trial reading for each chapter is described by the chapter structure information, trial reading can be controlled on the basis of smaller units.

According to another aspect of the invention, a computer-readable recording medium having electronic book contents recorded thereon, the electronic book contents including a body data unit and a part data unit. The body data unit includes event data including a description for designating a display region and a first identifier for designating contents displayed on the display region, and the part data unit includes display data divided into a plurality of regions with the first identifier added thereto.

As the event data includes the description for designating the display region and the first identifier for designating the contents displayed on the display region, the display data can be acquired and then displayed on the display region by referring to the first identifier added to the display data.

According to still another aspect of the invention, an electronic book display apparatus displays electronic book contents including a body data unit and a part data unit. The body data unit includes event data including a description for designating a display region and a first identifier for designating contents displayed on the display region. The part data unit includes display data divided into a plurality of regions with the first identifier added thereto. The electronic book display apparatus includes an event reading unit reading the event data, an object reading unit referring to the first identifier in the event data read by the event reading unit to read the display data in the part data, and a display unit displaying the display data read by the object reading unit according to the description for designating the display region in the event data read by the event reading unit.

As the display unit displays the display data read by the object reading unit according to the description for designating the display region in the event data read by the event reading unit, the electronic book contents can be displayed with a reduced time required for an editing operation.

Preferably, the event data further includes a second identifier for designating sound data to be reproduced, the part data unit further includes the sound data divided into a plurality of regions with the second identifier added thereto, and the electronic book display apparatus further includes a sound object reading unit referring to the second identifier in the event data read by the event reading unit to read the sound data in the part data, and a reproduction unit reproducing the sound data read by the sound object reading unit.

As the reproduction unit reproduces the sound data read by the sound object reading unit, the sound data can be reproduced with a reduced time required for an editing operation.

According to a further aspect of the invention, an electronic book transmission apparatus transmits electronic book contents including a body data unit and a part data unit. The body data unit includes event data including a description for designating a display region and a first identifier for designating contents displayed on the display region. The part data unit includes display data divided into a plurality of regions with the first identifier added thereto. The electronic book transmission apparatus includes a storage unit storing a plurality of electronic book contents and a transmission unit transmitting desired electronic book contents from the plurality of electronic book contents stored in the storage unit.

As the transmission unit transmits desired electronic book contents from a plurality of electronic book contents stored in the storage unit, the electronic book contents can be transmitted with a reduced time required for an editing operation.

### BRIEF DESCRIPTION OF THE DRAWINGS

FIG. 1 shows an example of conventional electronic book data.

FIG. 2 is a schematic block diagram showing a data structure of electronic book data according to a first embodiment of the present invention.

FIG. 3 shows one example of book information.

FIG. 4 shows one example of description in bibliography data 11.

FIG. 5 shows one example of description in a chapter structure information unit 121.

FIG. 6 shows one example of description in event data 124.

FIG. 7 shows one example of an image object entry unit.

FIG. 8 shows one example of a text object entry unit.

FIG. 9 shows one example of a sound object entry unit.

FIG. 10 shows an external view as an example of an electronic book display apparatus according to a second embodiment of the present invention.

FIG. 11 is a block diagram showing a structure of the electronic book display apparatus according to the second embodiment of the invention.

FIG. 12 is a schematic block diagram showing a functional structure of the electronic book display apparatus according to the second embodiment of the invention.

FIG. 13 is a flowchart illustrating a processing procedure of the electronic book display apparatus according to the second embodiment of the invention.

FIG. 14 generally illustrates a process followed by an electronic book transmission apparatus according to a third embodiment of the invention.

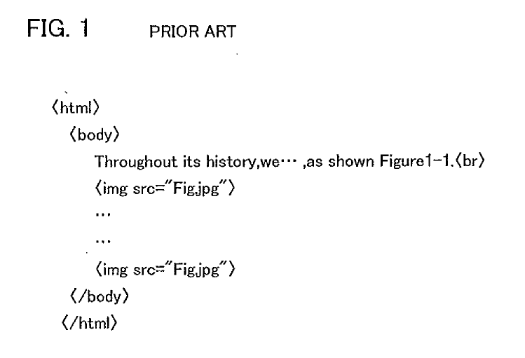

### BEST MODES FOR CARRYING OUT THE INVENTION

### First Embodiment

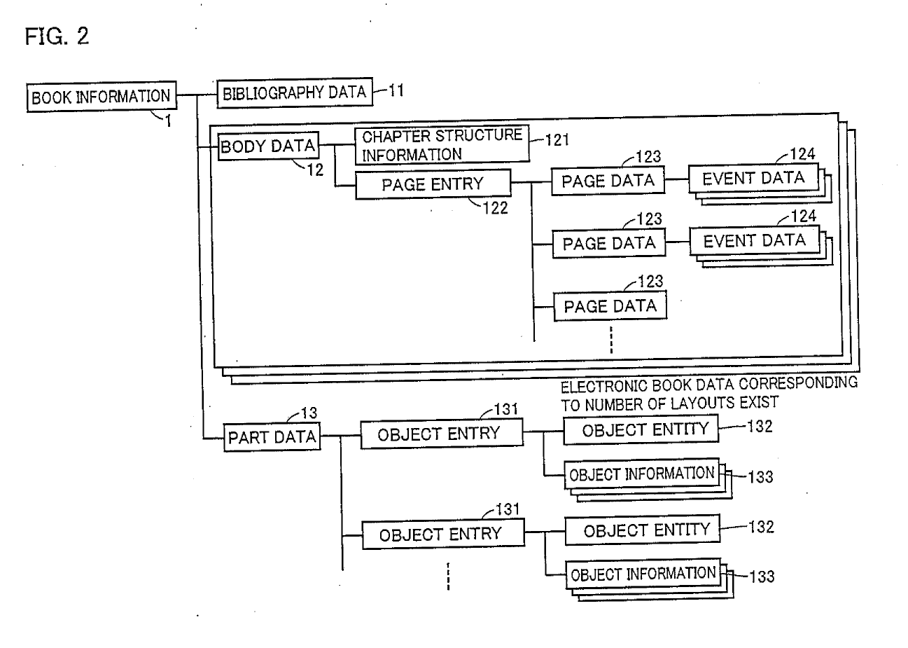

FIG. 2 is a schematic block diagram showing a data structure of electronic book data according to a first embodiment of the present invention. Book information 1 is a module for managing the entire electronic book data and includes subordinate modules, namely bibliography data 11, body data 12 and part data 13.

Body data 12 is a module for managing logical attributes such as page layout, chapter, section and the like, and there may be a plurality of body data modules for respective layouts. Each body data module 12 includes chapter structure information 121 and page entry 122 that are subordinate modules. Page entry 122 is a module for managing page data corresponding to each page and includes a plurality of page data 123 as subordinate modules. Page data 123 is present for each page and includes a plurality of event data 124 as subordinate modules.

Part data 13 is a module for managing object data as part data and includes a plurality of object entry modules 131 as subordinate modules. Object entry 131 is a module for entering an object to be used for a page among object entities and includes an object entity 132 and a plurality of object information pieces 133. Object entity 132 indicates an entity of the object allocated to the page. Object information 133 is present for each instance of the object and has information for use in allocating object entity 132 to the page.

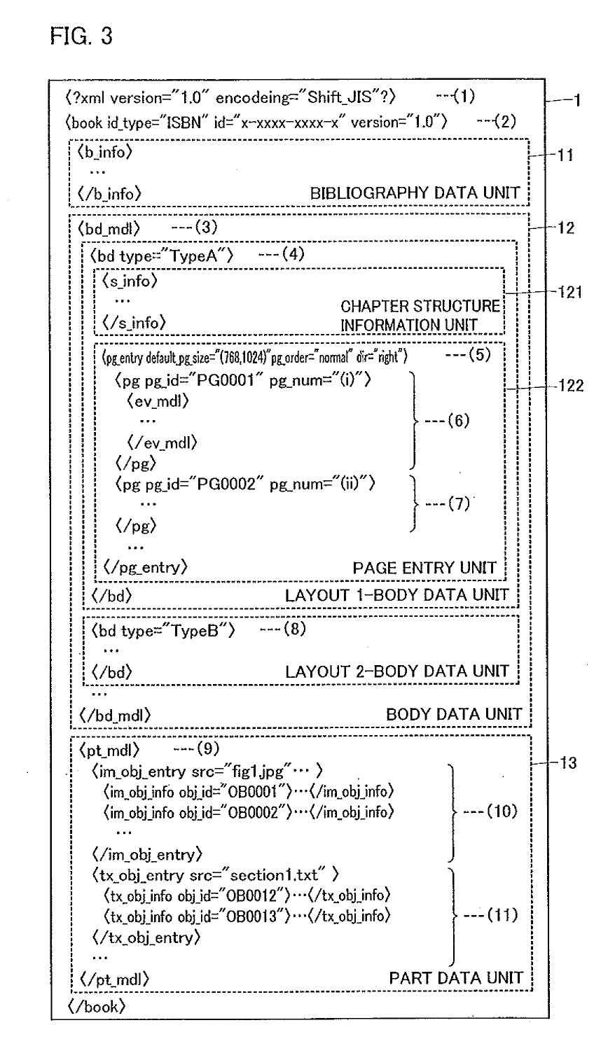

FIG. 3 shows one example of the book information. The book information corresponds to the schematic block diagram of the data structure shown in FIG. 2 and the same components are denoted by the same reference character. Book information 1 is described in the form of xml (Extensible Markup Language) as indicated in line (1). <book> tag shown in line (2) of book information 1 indicates that a book information module is described below. The <book> tag has an id_type attribute designating a type of an ID number and an id attribute and respective attributes indicate that the ID number type is “ISBN” and the ID number is “x-xxxx-xxxx-x”. This book information 1 includes a bibliography data unit 11, a body data unit 12 and a part data unit 13. Bibliography data unit 11 is detailed later.

Body data unit 12 includes a plurality of body data units (layout 1-body data unit and layout 2-body data unit) corresponding to respective layouts. <bd_mdl> tag shown in line (3) in body data unit 12 indicates that a plurality of body data units are described below corresponding to respective layouts. By this <bd_mdl> tag, a plurality of display layouts can be included according to specifications of electronic book display apparatuses as described later.

Line (4) in the layout 1-body data unit shows <bd> tag which indicates that descriptions of chapter structure information unit 121 and page entry unit 122 follow. This <bd> tag has a type attribute indicating the type of an electronic book display apparatus for displaying this body data, and indicates here that the type of the electronic book display apparatus is “Type A”. Chapter structure information unit 121 is detailed later.

Line (5) in page entry unit 122 shows <pg_entry> tag which indicates that each page data 123 is described below. This <pg_entry> tag includes default_pg_size attribute indicating default size of each page, pg_order attribute designating page order of the book and dir attribute designating direction of turning a page. Respective attributes show that the default size of the page is “(768, 1024)”, page order of the book is “normal (order of store)” and page turning direction is “right (turn to the right)”.

In (6) in page entry unit 122, page data 123 corresponding to page ID number “PG0001” and event data 124 are described. In (7) in page entry unit 122, page data 123 corresponding to page ID number “PG0002” and event data 124 are described as detailed later.

<bd> tag shown in line (8) in the layout 2-body data unit shows that chapter structure information unit 121 and page entry unit 122 of layout 2 are described below, and the type attribute indicates that an electronic book display apparatus for displaying this body data has type “Type B”. Information corresponding to chapter structure information unit 121 and page entry unit 122 is described subsequently to line (8).

<pt_mdl> tag shown in line (9) in part data unit 13 indicates that a plurality of object entries 131 are described in the following and these are generally divided into image object entry units, text object entry units and sound object entry units. (10) in part data unit 13 shows description of image object entry units. (11) in part data unit 13 shows description of text object entry units. These are detailed later.

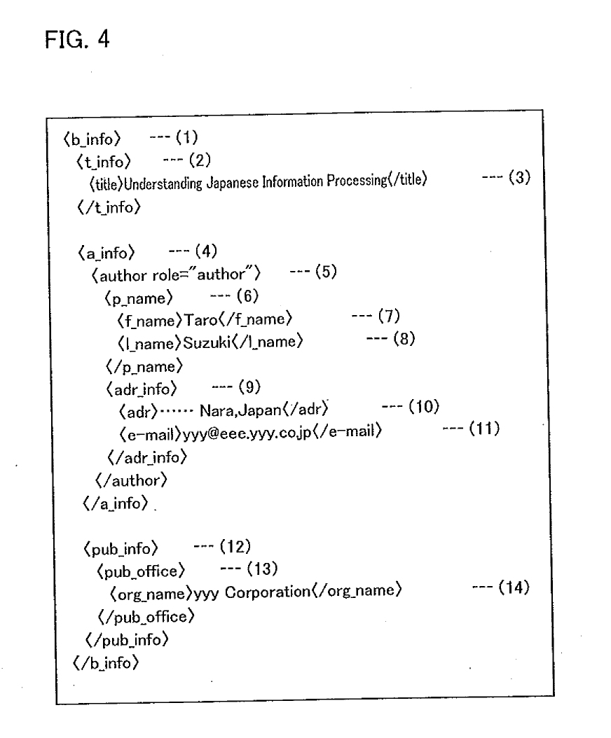

FIG. 4 shows one example of description of bibliography data 11. <b_info> tag shown in line (1) indicates that bibliography information such as title name and author name of the book is described below. <t_info> tag shown in line (2) indicates that title information is described below. Further, <title> tag in line (3) shows that the title is “Understanding Japanese Information Processing”.

<a_info> tag shown in line (4) indicates that information about the author is subsequently described. <author> tag shown in line (5) designates the type of the author, namely whether the author is writer, editor or the like and role attribute here indicates the type is “author (writer)”. <p_name> tag shown in line (6) indicates that the name of the author is described below and includes <f_name> tag and <l_name> tag. <f_name> tag shown in line (7) indicates that the first name follows and “Taro” is described as the first name. <l_name> tag shown in line (8) indicates that the last name follows and “Suzuki” is described as the last name.

<adr_info> tag shown in line (9) indicates that address information of the author follows and includes <adr> tag and <e-mail> tag. <adr> tag shown in line (10) indicates that an address of the author follows and “ . . . Nara, Japan” is described as the address. <e-mail> tag shown in line (11) indicates that an e-mail address follows and “yyy@eee.yyy.co.jp” is described as the e-mail address.

<pub_info> tag shown in line (12) indicates that information about the publishing company is subsequently described and <pub_office> tag shown in line (13) indicates that publishing company information follows. In addition, <org name> tag shown in line (14) indicates that the name of the publishing company follows and “yyy Corporation” is described as the name of the publishing company.

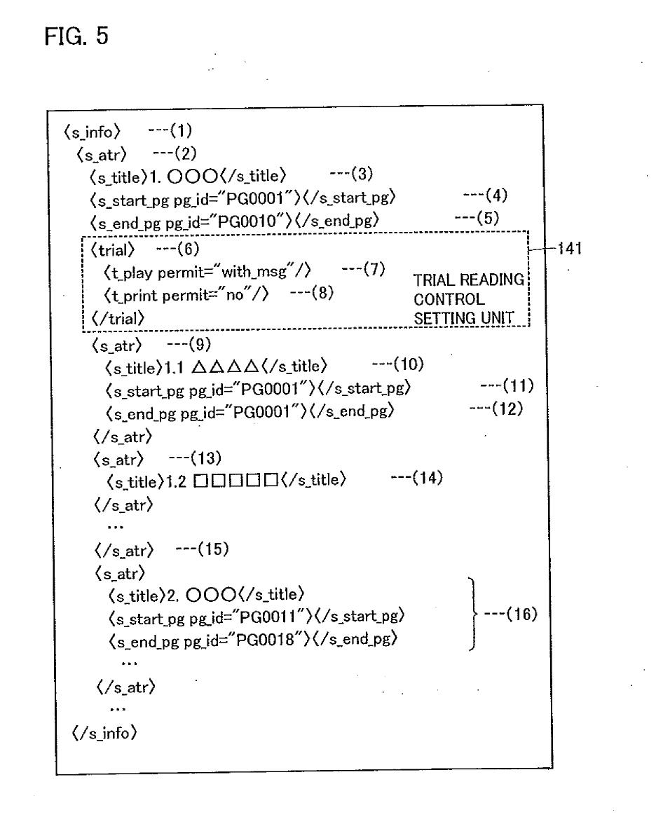

FIG. 5 shows one example of description in chapter structure information unit 121. <s_info> tag shown in line (1) indicates that a hierarchical structure of chapters of the book as well as title, initial and last pages and the like of each chapter or section are subsequently described. <s_atr> tag shown in line (2) indicates that chapter attribute information is described subsequently.

<s_title> tag shown in line (3) indicates that a title of a chapter follows and “1. ◯◯◯” is described as the title of this chapter. <s_start_pg> tag shown in line (4) indicates that information about the initial page of the chapter is described and pg id attribute designates the initial page “PG0001”. <s_end_pg> tag shown in line (5) indicates that information about the last page of the chapter is described subsequently and pg_id attributes designates the last page “PG0010”.

A trial reading control setting unit 141 shown in FIG. 5 is a region for designating information provided for copyright protection of this chapter (method of controlling trial reading). <trial> tag shown in line (6) indicates that the trial reading control method for this chapter is subsequently described. <t_play> tag shown in line (7) designates a control method concerning display/reproduction and permit attribute accordingly designates “with_msg” (display/reproduction is permitted if copyright message is attached). <t_print> tag shown in line (8) is used for designating a control method concerning printing and permit attribute accordingly designates “no” (printing is not permitted). When a user who does not purchase the electronic book data through a regular procedure is going to display/print the electronic book data, this situation is addressed by settings in trial reading control setting unit 141.

<s_atr> tag shown in line (9) indicates that information about a section included in this chapter is subsequently described. <s_title> tag shown in line (10) indicates that a title of the section follows and “1. 1ΔΔΔΔ” is described as the title of this section. <s_start_pg> tag shown in line (11) indicates that information about the initial page of the section follows and pg_id attribute accordingly designates “PG0001”. <s_end_pg> tag shown in line (12) indicates that information about the last page of the section follows and pg_id attribute accordingly designates “PG0001”.

<s_atr> tag shown in line (13) indicates that information about the next section is subsequently described. <s_title> tag shown in line (14) indicates that a title of this section follows and the title “1.2 [symbol] ” is described. Information about each section of this chapter is subsequently described.

Description in (16) following line (15) is chapter attribute information concerning a following chapter that corresponds to information shown from line (3) to line (15).

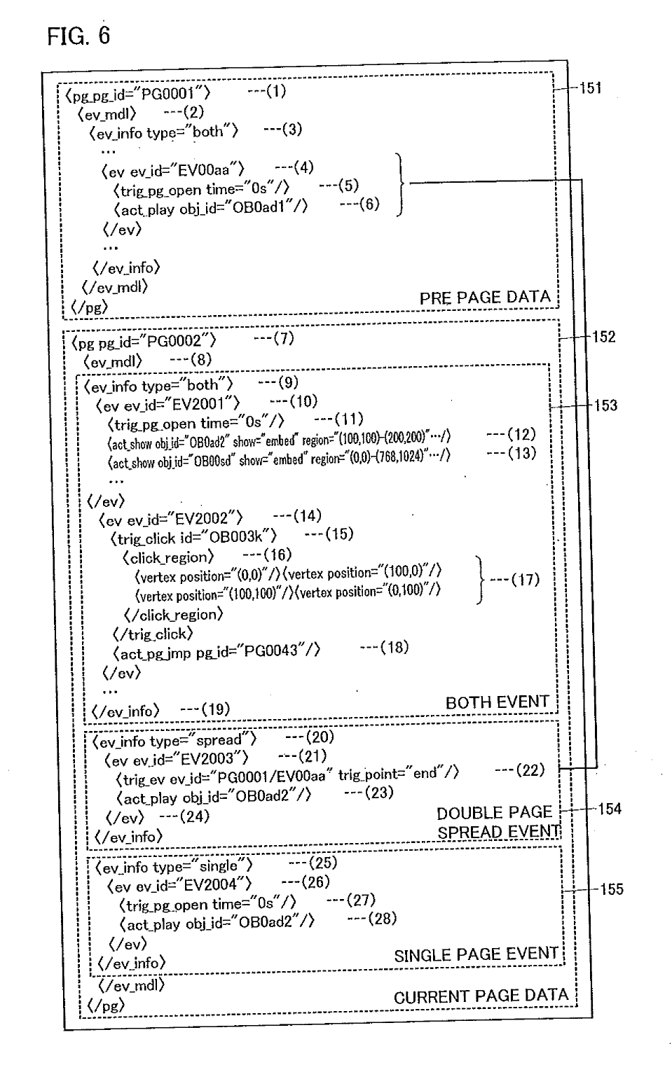

FIG. 6 shows one example of event data 124. The event data includes a pre page data 151 and a current page data 152. <pg> tag shown in line (1) indicates that information about pre page data 151 is subsequently described and pg_id attribute shows that page ID number is “PG0001”. <ev_mdl> tag shown in line (2) designates a method of reproducing the page as an event. Event management module <ev_mdl> has event information module <ev_info> as a child element and the maximum number of event information modules <ev_info> is three.

<ev_info> tag shown in line (3) indicates that an event allocated to the page is subsequently described. Type attribute designates a double-page spread display-dedicated event (double spread event), a single page display-dedicated event (single page event) or an event executable for both (both event). In line (3), the type attribute here designates the both event. In this event information module <ev_info>, event data <ev> is described as a unit for each display type designated by the type attribute.

Event data <ev> shown in line (4) is described by one trigger information and multiple pieces of action information. The trigger information is a condition for generating an event. When the trigger condition is satisfied, an action described correspondingly to the trigger is carried out. Event data <ev> shown in line (4) has ev_id attribute designating ID number of the event and accordingly event ID “EV00aa” is shown here.

<trig_pg open> tag shown in line (5) indicates that the time passed from the start of display of this page is used as a trigger. Time attribute shows that the time “0s” from the start of display of this page is used as the trigger. <act_play> tag shown in line (6) is used for designating reproduction and stop of an object having a time component like the reproduction of motion video, sound data or animation data. <act_play> tag has obj_id attribute designating an object to be reproduced and “OB0ad1” is designated here as object ID.

Current page data 152 includes three event information modules <ev_info>, namely, a both event 153, a double spread event 154 and a single page event 155. <pg> tag shown in line (7) indicates information about current page data 152 is subsequently described. pg_id attribute shows that page ID number is “PG0002”. <ev_mdl> tag shown in line (8) shows that a method of reproducing the page is designated as an event.

The type attribute of <ev_info> tag shown in line (9) in both event 153 indicates that the event information module <ev_info> here is “both” (both event). The ev_id attribute of <ev> tag shown in line (10) indicates that ID number of this event is “EV2001”. The time attribute of <trig_pg_open> tag shown in line (11) indicates that time “0s” from the start of display of the page is used as a trigger.

<act_show> tag shown in line (12) indicates an action for displaying an object without time component and includes obj_id attribute designating an object to be displayed, show attribute designating a display method of the object and region attribute designating a region where the object is displayed. These attributes respectively show that ID number of the object to be displayed is “OB0ad2”, the object display method is “embed” (embedded in a page) and the display region is “(100, 100)-(200, 200)”.

<act_show> tag shown in line (13) indicates that ID number of an object to be displayed is “OB00sd”, display method of the object is “embed” (embedded in a page) and display region is “(0, 0)-(768, 1024)”.

<ev> tag shown in line (14) indicates that another event is described and ID number of the event is shown as “EV2002”. <trig_click> tag shown in line (15) is described when the event is generated by a user clicking an object or character string in a page or a part of the page, and has <click_region> as a child element. This <trig_click> tag has id attribute designating an object to be clicked and object ID number “OB003k” is designated as the object to be clicked.

<click_region> tag shown in line (16) is used for designating a click region and has <vertex> as a child element discussed below. <vertex> tag shown in line (17) designates a vertex of a click region and has position attribute designating the coordinate of the vertex in an object coordinate system. Four <vertex> tags accordingly designate the click region which is a rectangle having vertexes (0, 0), (100, 0), (0, 100) and (100, 100).

<act_pg_jmp> tag shown in line (18) shows a command to change current display of a page to display of another page and has pg_id attribute designating ID number of the another page to be displayed. This pg_id attribute indicates that ID number of that another page to be displayed is “PG0043”. Lines (14) to (19) thus show that display is switched from the current page to page “PG0043” when the designated click region is clicked by four <vertex> tags.

<ev_info> tag shown in line (20) in double spread event 154 has type attribute which indicates that this event information module <ev_info> is “spread” (double spread event), <ev> tag shown in line (21) has ev_id attribute which indicates that this event data <ev> has ID number “EV2003”.

<trig_ev> tag shown in line (22) is designated when an event is generated synchronously with start/end of another event, and has ev_id attribute designating ID number of a target event and trig_point attribute designating a starting point flag for an event. These attributes respectively designate “EV00aa” in page “PG0001” as the target event and “end” (at the time of end) as the starting point flag for the event. Specifically, it is shown that, when event “EV00aa” in page “PG0001” is ended, an event is generated. <act_play> tag shown in line (23) has obj_id attribute designating “OB0ad2” as object ID. Accordingly, lines (21) to (24) show that at the time of end of event “EV00aa” in page “PG0001”, object reproduction of object “OB0ad2” is started.

<ev_info> tag shown in line (25) in single page event 155 has type attribute which indicates that this event information module <ev_info> is “single” (single page event). <ev> tag shown in line (26) has ev_id attribute which indicates ID number “EV2004” of this event data <ev>. <trig_pg_open> tag shown in line (27) has time attribute which indicates that time “0s” from the start of display of the page is used as a trigger. <act_play> tag shown in line (28) has obj_id attribute which designates “OB0ad2” as object ID.

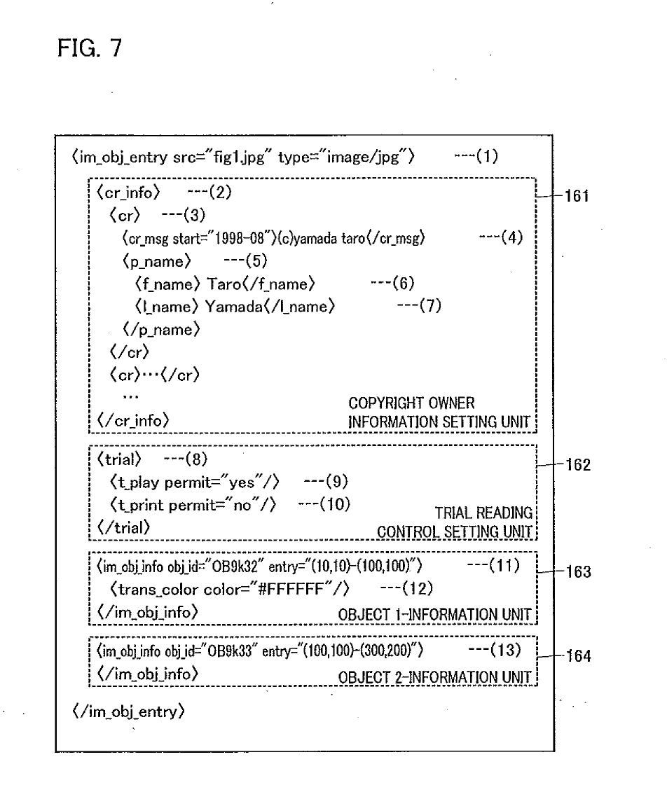

FIG. 7 shows one example of an image object entry unit. The image object entry unit includes a copyright owner information setting unit 161, a trial reading control setting unit 162, an object 1-information unit 163 and an object 2-information unit 164. Image object entry module <im_obj_entry> shown in line (1) indicates that the subsequent region is a region where an image object used in book information 1 is entered, and includes src attribute designating a file name of object entity 132 and type attribute designating type of the object entity. These attributes respectively designate “fig1.jpg” as the file name of the object entity and “image/jpg” as the type of the object entity (image data compressed by JPEG (Joint Photographic Experts Group). This image object entry module <im_obj_entry> has <cr_info> tag, <trial> tag and <im_obj_info> tag as child elements.

<cr_info> tag shown in line (2) in copyright owner information setting unit 161 indicates that copyright information of the object entity is subsequently described. <cr> tag shown in line (3) indicates that any message concerning copyright and name of a copyright owner are subsequently described. <cr_msg> tag shown in line (4) indicates that message concerning copyright is subsequently described and has start attribute designating year/month when the copyright is generated. The start attribute designates “1998-08” and “(c) yamada taro” is designated as a message concerning copyright.

<p_name> tag shown in line (5) indicates that the name of copyright owner is subsequently described and includes <f_name> tag and <l_name> tag. <f_name> tag shown in line (6) indicates that the first name follows and “Taro” is described as the first name. <l_name> tag shown in line (7) indicates that the last name follows and “Yamada” is described as the last name.

<trial> tag shown in line (8) in trial reading control setting unit 162 indicates that a method of controlling trial reading of the object entity is described and includes <t_play> tag and <t_print> tag. <t_play> tag shown in line (9) designates a control method concerning display/reproduction and permit attribute accordingly designates “yes” (display/reproduction is permitted). <t_print> tag shown in line (10) is used for designating a control method concerning printing and permit attribute accordingly designates “no” (printing is inhibited).

Image object information module <im_obj_info> shown in line (11) in object-1 information unit 163 indicates that, in this region, image object entity 132 is partially or entirely entered as an object, and includes obj_id attribute designating ID number of the object and entry attribute designating a region in the object entity to be entered by object coordinate system. These attributes accordingly designate “OB9k32” as ID number of the object and region “(10, 10)-(100, 100) of the image object entity 132 as the object. Image object information module <im_obj_info> has <trans_color> tag as a child element.

<trans_color> tag shown in line (12) designates a color of a transparent region in an image and color attribute accordingly designates transparent color “#FFFFFF”.

obj_id attribute and entry attribute of the image object information module shown in line (13) in object 2-information unit 164 indicates that the image object has ID number “OB9k33” and region “(100, 100)-(300, 200) of image object entity 132 is designated as an object.

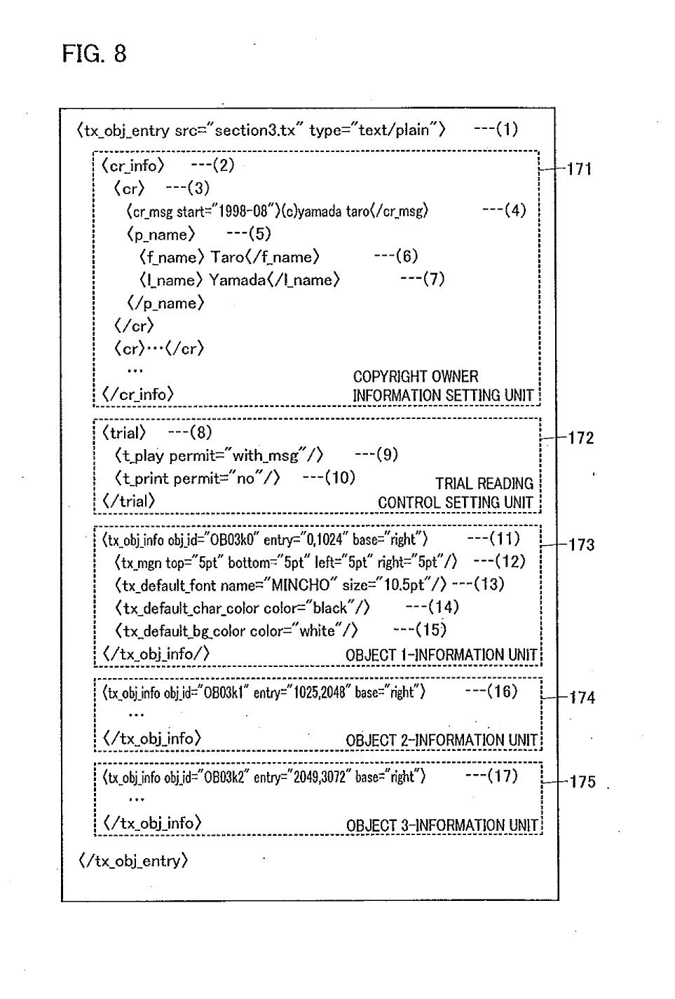

FIG. 8 shows one example of a text object entry unit. The text object entry unit includes a copyright information setting unit 171, a trial reading control setting unit 172, an object 1-information unit 173, an object 2-information unit 174, and an object 3-information unit 175. Text object entry module <tx_obj_entry> shown in line (1) indicates that a text object used in book information 1 is entered in this region, and includes src attribute designating file name of object entity 132 and type attribute designating type of the object entity. These attributes respectively designate “section3. tx” as the file name of the object entity and “text/plain” (text) as the type of the object entity. Text object entry module <tx_obj_entry> includes <cr_info> tag, <trial> tag and <tx_obj_info> tag as child elements.

<cr_info> tag shown in line (2) in copyright owner information setting unit 171 indicates that copyright information of the object entity is subsequently described. <cr> tag shown in line (3) indicates that any message concerning copyright and name of a copyright owner are subsequently described. <cr_msg> tag shown in line (4) indicates that message concerning copyright is subsequently described and has start attribute designating year/month when the copyright is generated. The start attribute designates “1998-08” and “(c) yamada taro” is designated as a message concerning copyright.

<p_name> tag shown in line (5) indicates that the name of copyright owner is subsequently described and includes <f_name> tag and <l_name> tag. <f_name> tag shown in line (6) indicates that the first name follows and “Taro” is described as the first name. <l_name> tag shown in line (7) indicates that the last name follows and “Yamada” is described as the last name.

<trial> tag shown in line (8) in trial reading control setting unit 172 indicates that a method of controlling trial reading of the object entity is described and includes <t_play> tag and <t_print> tag. <t_play> tag shown in line (9) designates a control method concerning display/reproduction and permit attribute accordingly designates “with_msg” (display/reproduction is permitted if copyright message is attached). <t_print> tag shown in line (10) is used for designating a control method concerning printing and permit attribute accordingly designates “no” (printing is inhibited).

Text object information module <tx_obj_info> shown in line (11) in object-1 information unit 173 indicates that, in this region, text object entity 132 is partially or entirely entered as an object, and includes obj_id attribute designating ID number of the object, entry attribute designating a region in the object entity entered as the object, and base attribute designating direction of a base line. These attributes respectively designate “OB03k0” as ID number of the object, region “0, 1024” (0th byte character to 1024th byte character) as the region of text object entity 132 and “right” (from left to right) as the direction of the base line. This text object information module <tx_obj_info> has <tx_mgn> tag, <tx_default_font> tag, <tx_default_char_color> tag, and <tx_default_bg_color> tag as child elements.

<tx_mgn> tag shown in line (12) designates a margin with respect to the display region, and has top attribute designating a top margin, bottom attribute designating a bottom margin, left attribute designating a left margin, and right attribute designating a right margin. These attributes respectively designate “5pt” (5 points) as the top margin, “5pt” as the bottom margin, “5pt” as the left margin, and “5pt” as the right margin.

<tx_default_font> tag shown in line (13) designates values that are set concerning default font and includes name attribute designating default font name and size attribute designating default font size. These attributes respectively designate “Mincho” as the default font name and “10.5pt” as the default font size.

<tx_default_char_color> tag shown in line (14) designates a basic character color used for displaying character strings and has color attribute used for designating a character color different from a default value designated in the object entity. This color attribute designates “black” as the character color.

<tx_default_bg_color> tag shown in line (15) designates a basic background color used for displaying character strings and has color attribute used for designating a background color different from a default value designated in the object entity. This color attribute designates “white” as the background color.

Text object information module <tx_obj_info> shown in line (16) in object 2-information unit 174 has obj_id attribute, entry attribute and base attribute that respectively designate “OB03k1” as ID number of the object, region “(1025, 2048)” of text object entity 132 as the object and “right” (from left to right) as the direction of a base line.

Text object information module <tx_obj_info> shown in line (17) in object 3-information unit 175 has obj_id attribute, entry attribute and base attribute that respectively designate “OB03k2” as ID number of the object, region “(2049, 3072)” of text object entity 132 as the object and “right” (from left to right) as the direction of a base line.

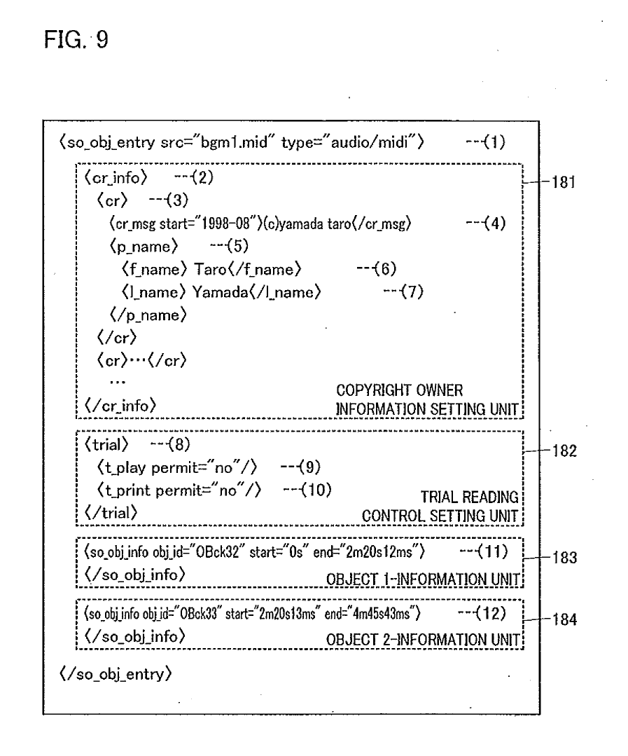

FIG. 9 shows one example of a sound object entry unit. The sound object entry unit includes a copyright owner information setting unit 181, a trial reading control setting unit 182, an object 1-information unit 183 and an object 2-information unit 184. Sound object entry module <so_obj_entry> shown in line (1) indicates that a sound object used in book information 1 is entered in this region, and includes src attribute designating a file name of object entity 132 and type attribute designating type of the object entity. These attributes respectively designate “bgm1. mid” as the file name of the object entity and “audio/midi” as the type of the object entity (file system produced for MIDI (Musical Instrument Digital Interface)). This sound object entry module <so_obj_entry> has <cr_info> tag, <trial> tag and <so_obj_info> tag as child elements.

<cr_info> tag shown in line (2) in copyright owner information setting unit 181 indicates that copyright information of the object entity is subsequently described. <cr> tag shown in line (3) indicates that any message concerning copyright and name of a copyright owner are subsequently described. <cr_msg> tag shown in line (4) indicates that message concerning copyright is subsequently described and has start attribute designating year/month when the copyright is generated. The start attribute designates “1998-08” and “(c) yamada taro” is designated as a message concerning copyright.

<p_name> tag shown in line (5) indicates that the name of copyright owner is subsequently described and includes <f_name> tag and <l_name> tag. <f_name> tag shown in line (6) indicates that the first name follows and “Taro” is described as the first name. <l_name> tag shown in line (7) indicates that the last name follows and “Yamada” is described as the last name.

<trial> tag shown in line (8) in trial reading control setting unit 182 indicates that a method of controlling trial reading of the object entity is described and includes <t_play> tag and <t_print> tag. <t_play> tag shown in line (9) designates a control method concerning display/reproduction and permit attribute accordingly designates “no” (display/reproduction is inhibited). <t_print> tag shown in line (10) is used for designating a control method concerning printing and permit attribute accordingly designates “no” (printing is inhibited).

Sound object information module <so_obj_info> shown in line (11) in object-1 information unit 183 indicates that, in this region, sound object entity 132 is partially or entirely entered as an object, and includes obj_id attribute designating ID number of the object, start attribute designating a start time of the region in the object entity entered as the object, and end attribute designating an ending time of the, region in the object entity entered as the object. These attributes respectively designate “OBck32” as ID number of the object and region “0s-2m20s12ms” (region from 0 second to 2 minutes and 20 seconds and 12 milliseconds) as sound object entity 132.

The obj_id attribute, start attribute and end attribute of the sound object information module shown in line (12) in object 2-information unit 184 indicate that the sound object has ID number “OBck33” and region “2m20s13ms-4m45s43ms” of sound object entity 132 is designated as an object.

As heretofore discussed, according to the electronic book data of this embodiment, a part of object entity 132 in part data 13 is entered as an object with an ID number added thereto and the ID number of the object is designated in each page data 123 of body data 12. Accordingly, if object entity 132 is image data, for example, update of contents in all pages using the object in body data 12 is possible by merely changing the file name of the image data in object entity 132 of part data 13. Consequently, it is possible to remarkably shorten the time required for editing the electronic book data.

A part of text data, image data or the like can be entered as an object, and display data is divided to allow the display data to be stored for each page. It is thus possible to jump to any page at random. Replacement of pages or addition of an advertisement page for example can be prevented from affecting other pages. Moreover, page-by-page sale can easily be conducted to allow only one page of an electronic book to be sold.

Copyright information is described for each part data so that the copyright can be managed on the basis of smaller units and thus there occur less problems concerning copyright. In addition, information about copyright is set for each chapter to allow electronic book data to be sold chapter by chapter.

Event data 124 are described separately for double page spread display, single page display and display adaptable to both and thus various display forms can be addressed. In particular, when electronic book data is created to provide a sound of reading of each page, events are described for the double page spread display such that a reading sound of one page is generated and thereafter a reading sound of the other page is generated. Accordingly, it never occurs that respective reading sounds of spread two pages are simultaneously produced.

The body data 12 are provided that are equal in number to the number of layouts. Then, display adapted to the performance of an electronic book display apparatus is possible.

### Second Embodiment

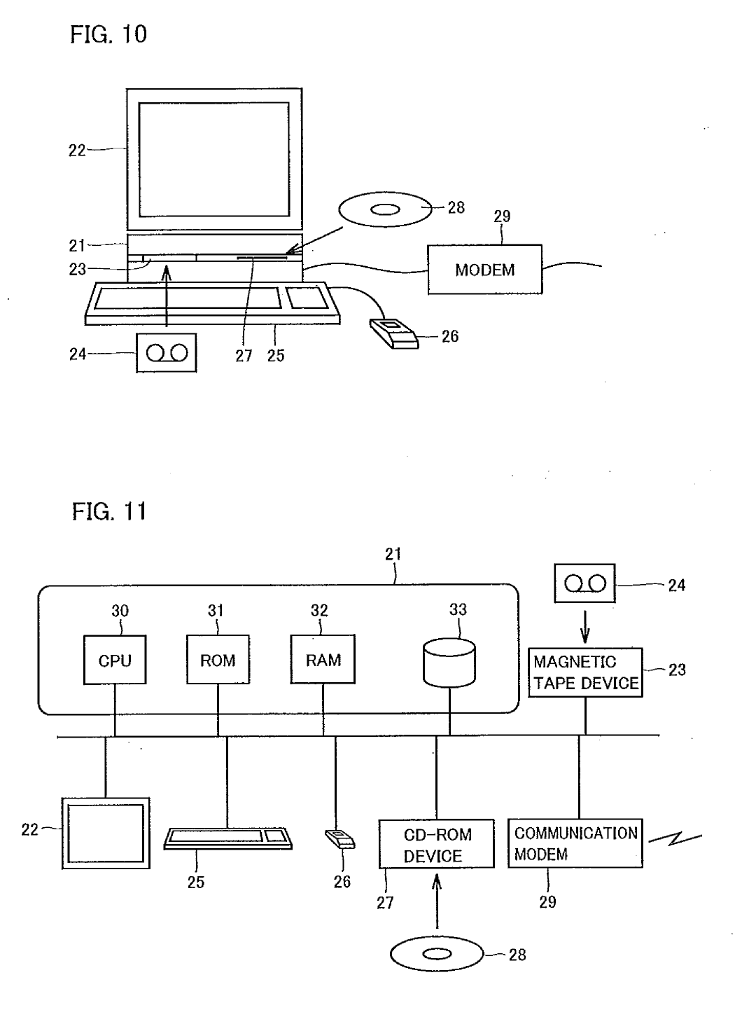

FIG. 10 shows an external view as an example of an electronic book display apparatus displaying the electronic book data as explained in connection with the first embodiment. The electronic book display apparatus includes a computer body 21, a graphic display device 22, a magnetic tape device 23 where a magnetic tape 24 is placed, a keyboard 25, a mouse 26, a CD-ROM device 27 where a CD-ROM (Compact Disk-Read Only Memory) 28 is placed, and a communication modem 29. Electronic book data transmitted from an electronic book transmission apparatus herein described later is received via communication modem 29. The electronic book data may be supplied by means of any storage medium like magnetic tape 24, CD-ROM 28 or the like.

An electronic book display program used for displaying the electronic book data on graphic display device 22 may be stored in advance within computer body 21 or supplied by a storage medium such as magnetic tape 24, CD-ROM 28 or the like. The electronic book display program is executed by computer body 21. An operator operates keyboard 25 or mouse 26 while watching graphic display device 22 to allow the electronic book data to be displayed. Alternatively, the electronic book display program may be supplied to computer body 21 via communication modem 29 from another computer through a communication line.

FIG. 11 is a block diagram showing an example of a structure of the electronic book display apparatus according to the present invention. Computer body 21 shown in FIG. 10 includes a CPU 30, a ROM (Read Only Memory) 31, a RAM (Random Access Memory) 32, and a hard disk 33. CPU 30 operates by input/output of data from/to graphic display device 22, magnetic tape device 23, keyboard 25, mouse 26, CD-ROM device 27, communication modem 29, ROM 31, RAM 32 or hard disk 33. When the electronic book display program is supplied by magnetic tape 24 or CD-ROM 28, the program is temporarily stored in hard disk 33 by CPU 30 via magnetic tape device 23 or CD-ROM device 27. CPU 30 appropriately loads the electronic book display program from hard disk 33 into RAM 32 and executes the program to display the electronic book data. Electronic book data received via communication modem 29, or electronic book data supplied by magnetic tape 24 or CD-ROM 28 is temporarily stored in hard disk 33.

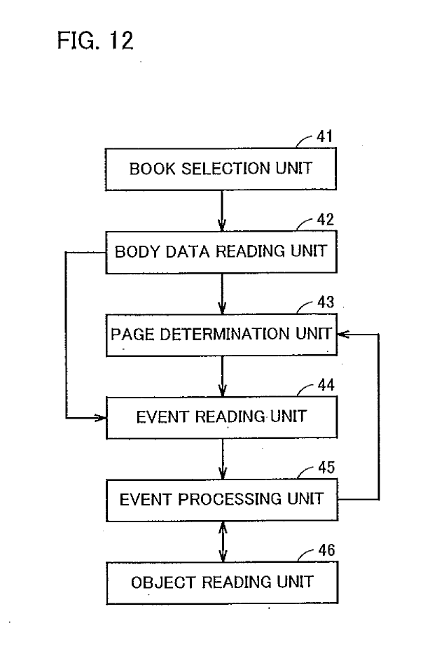

FIG. 12 is a schematic block diagram showing a functional structure of the electronic book display apparatus according to this embodiment. The electronic book display apparatus includes a book selection unit 41 for selecting desired electronic book data from a plurality of electronic book data, a body data reading unit 42 for reading body data of the electronic book data selected by book selection unit 41, a page determination unit 43 for determining a page to be displayed on a screen, an event reading unit 44 for reading event data in the body data read by body data reading unit 42, an event processing unit 45 for processing an event described in the event data, and an object reading unit 46 for reading an object designated in the event data.

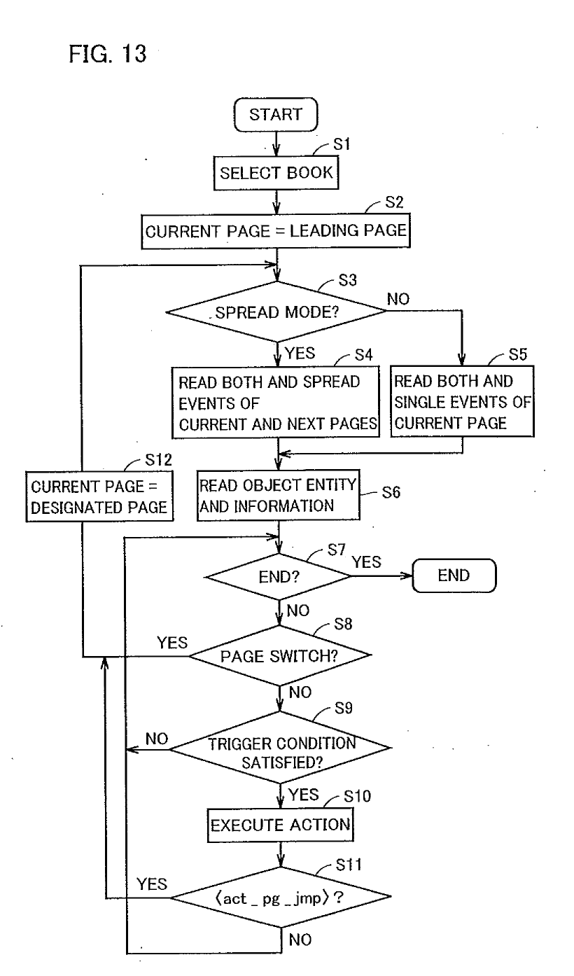

FIG. 13 is a flowchart illustrating a processing procedure of the electronic book display apparatus according to this embodiment. Book selection unit 41 selects electronic book data designated by a user (S1). The user selects the electronic book data, for example, by manipulating keyboard 25 or mouse 26 to select one of a plurality of electronic book data titles presented on graphic display device 22. Body data reading unit 42 reads, from hard disk 33, body data 12 of the electronic book data selected by book selection unit 41. If there are a plurality of body data (layout 1-body data unit, layout 2-body data unit) as shown by body data 12 in FIG. 3, body data reading unit 42 selects any body data appropriate for the performance (resolution of the display screen and the like) of the electronic book display apparatus and reads the selected body data.

Page determination unit 43 determines a leading page displayed on the screen (S2). As shown in page entry unit 122 in FIG. 3, the order of <pg> tags described in page entry module <pg_entry> corresponds to page order. Accordingly, page determination unit 43 acquires pg_id attribute of <pg> tag described first in page entry module <pg_entry> of body data 12 read by body data reading unit 42 in order to determine the leading page.

Event reading unit 44 determines whether or not a mode of displaying the electronic book in a spread state is set (S3). This mode is set in advance by the user. If the mode of displaying the electronic book in the spread state is set (S3, Yes), event reading unit 44 reads a both event (event designated as “both” by type attribute of <ev_info> tag) and a spread event (event designated as “spread” by type attribute of <ev_info> tag) and thus acquires the events to be displayed on right and left portions of the screen (S4). If the mode of displaying the electronic book in the spread state is not set (S3, No), event reading unit 44 reads the both event and a single event (event designated as “single” by type attribute of <ev_info> tag) and thus acquires the events to be displayed on the screen (S5).

Event processing unit 45 analyzes the events read by event reading unit 44 to acquire object ID designated in the events (object ID designated by obj_id attribute of <act_show> tag or <act_play> tag). Object reading unit 46 reads object information 133 corresponding to this object ID from part data 13. Object reading unit 46 further refers to object information 133 to read a region entered as an object (region designated by entry attribute of <im_obj_info> tag, region designated by entry attribute of <tx_obj_info> tag or region designated by start and end attributes of <so_obj_info> tag) (S6).

It is then determined whether or not the user commands to break off reading (display of electronic book data) (S7). If the user commands to break off reading (S7, Yes), the process is terminated. If the user issues no command to break off reading (S7, No), it is determined whether user commands to switch the page (S8). The command of page switching is issued by clicking of “pre page button” or “next page button” indicated on the screen for example by mouse 26.

If the page switch command is issued (S8, Yes), the process proceeds to step S12. If the page switch command is not issued (S8, No), event processing unit 45 retrieves a trigger condition of the event of the currently displayed page to determine if there is an event satisfying the trigger condition (S9). If no event satisfies the trigger condition (S9, No), the process returns to step S7. If any event satisfies the trigger condition (S9, Yes), event processing unit 45 executes an action (<act_show> tag or <act_play> tag) of that event (S10). However, if the user does not purchase the electronic book through a regular procedure, the process follows setting of the trial reading control setting unit in a chapter including the current page in the chapter structure information unit (see FIG. 5). Specifically, if “no” (display/reproduction is inhibited) is designated by the permit attribute of <t_play> tag, event processing unit 45 carries out no action of display or reproduction of the object. If the permit attribute of <t_play> tag designates “yes” (display/reproduction is permitted), display/reproduction is done following the trial reading control setting of the object. If the permit attribute of <t_play> tag designates “with_msg” (display/reproduction is permitted on the condition that a copyright message is attached), any character string like “trial reading now proceeding” is displayed about the central part of the page to obstruct viewing.

If the action is <act_show>, event processing unit 45 shows the designated object in the region designated by the region attribute. If the user does not purchase the electronic book data through a regular procedure, event processing unit 45 displays the object following setting of the trial reading control setting unit of object information 133.

If the action is <act_play>, event processing unit 45 reproduces the designated object. If the user does not purchase the electronic book data through a regular procedure, event processing unit 45 reproduces the object following setting of the trial reading control setting unit of object information 133.

If the action is <act_pg_jmp> (S11, Yes), event processing unit 45 notifies page determination unit 43 of page ID designated by pg_id attribute. Page determination unit 43 updates the current page to the page designated by page ID notified by event processing unit 45 (S12), and then the process from step S3 is repeated.

As described above, by the electronic book display apparatus according to this embodiment, the advantages of the electronic book data discussed in connection with the first embodiment can fully be provided.

### Third Embodiment

An electronic book transmission apparatus according to a third embodiment of the present invention transmits the electronic book data described in connection with the first embodiment by request from a user. The electronic book transmission apparatus of this embodiment is the same in terms of the external view and schematic structure as the electronic book display apparatus shown in FIGS. 10 and 11 and thus detailed description thereof is not repeated here.

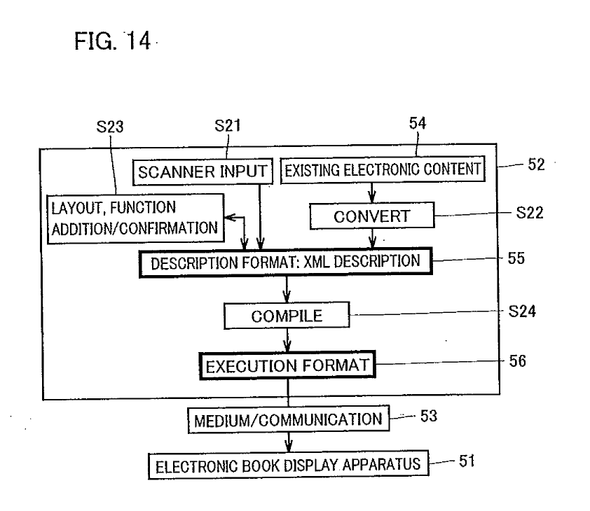

FIG. 14 generally illustrates a process followed by the electronic book transmission apparatus of this embodiment. The electronic book transmission apparatus is denoted by reference numeral 52 for description thereof.

Electronic book transmission apparatus 52 converts an electronic book into a description format 55 by scanner input (S21). An author or producer performs layout change, addition and confirmation of function as necessary on description format 55 (S23).

Existing electronic contents 54 are electronic contents produced by any description method except for XML description. Existing electronic contents 54 are converted by a converter into a description format (XML description) (S22). The electronic contents thus produced undergo confirmation of layout, image quality and functions on description format 55. The electronic book data described above corresponds to these electronic contents. The electronic contents are converted by a format compiler into an execution format 56 and then undergoes a process concerning data arrangement, change of description system and copyright protection.

The electronic contents thus converted into the execution format are stored in hard disk 33 and then provided by any medium such as CD-ROM 28 by request from a user or transmitted via communication modem 29 to electronic book display apparatus 51 used by the user.

As heretofore discussed, the electronic book transmission apparatus according to this embodiment makes it possible to provide the electronic book data having those advantages as described in connection with the first embodiment by request from users.

Embodiments herein disclosed are by way of illustration and example only in all respects and not to be taken by way of limitation. It is intended that the scope of the invention is shown not by the description above but by the appended claims and all modifications are included equivalent to and within the scope of the claims.

1. Electronic book contents comprising a body data unit (12) and a part data unit (13),
said body data unit (12) including event data (124) including a description for designating a display region and a first identifier for designating contents displayed on the display region, and
said part data unit (13) including display data (132) divided into a plurality of regions with said first identifier added hereto.

2-18. (canceled)
